(19) United States
(12) Patent Application Publication
(10) Pub. No.: US 2025/0353626 A1
(43) Pub. Date: Nov. 20, 2025

(54) DRUM-TYPE DOSING APPARATUS

(71) Applicant: Harro Hoefliger Verpackungsmaschinen GmbH, Allmersbach im Tal (DE)

(72) Inventors: Thomas Puppich, Allmersbach im Tal (DE); Lena Dietz, Allmersbach im Tal (DE); Reiner Wurst, Allmersbach im Tal (DE); Thomas Wall, Allmersbach im Tal (DE)

(21) Appl. No.: 19/208,372

(22) Filed: May 14, 2025

(30) Foreign Application Priority Data
May 16, 2024 (EP) 24176374.7

(51) Int. Cl. B65B 1/36; A61J 3/07

(52) U.S. Cl. CPC B65B 1/366; A61J 3/071

(57) ABSTRACT

A drum-type dosing apparatus is for producing individual dosing quantities of a pulverulent product. The drum-type dosing apparatus includes a product store which is arranged in a filling position, a dosing drum and also a rotary drive for the dosing drum. The dosing drum has circumferentially distributed dosing openings. At least two dosing openings spaced apart from one another in a circumferential direction of the dosing drum are combined to form a joint dosing portion. The rotary drive is configured for stepwise rotation of the dosing drum about an axis of rotation such that an individual dosing portion with the associated dosing openings ends up located, over the course of a cycle, at least in the filling position and in a discharging position.

### CROSS-REFERENCE TO RELATED APPLICATIONS

This application claims priority of European patent application no. 24176374.7, filed May 16, 2024, the entire content of which is incorporated herein by reference.

### BACKGROUND

For example the pharmaceuticals sector, but also the field of food supplements or the like, involves the processing of powders which, for the intended dosage form, have to be provided in precisely measured-out sub-quantities or dosing quantities. Target containers for example in the form of blisters, two-piece capsules or the like are filled with such measured-out dosing quantities of a pulverulent product, so that the consumer has at their disposal, and is able to take, corresponding single doses.

Such pulverulent products are converted, in particular on so-called drum-type dosing apparatuses, into individually measured-out dosing quantities, which are then introduced into respectively assigned target containers. Such a drum-type dosing apparatus includes a product store, a dosing drum and also a rotary drive for the dosing drum.

The dosing drum has a plurality of dosing openings distributed over its circumference. The dosing drum is rotated in a stepwise manner about an axis of rotation, so that an individual dosing opening or an axis-parallel row of dosing openings ends up located in different positions. A product store is located in a first position of these, namely in a filling position. In the filling position, the pulverulent product is sucked into the row of dosing openings from the product store for example under the action of negative pressure. This results in the formation of powder dosing quantities of which the volume corresponds to the volume of the respective dosing opening. Following the filling operation, the dosing drum is rotated onwards in a stepwise manner to the extent where the row of previously filled dosing openings then ends up located in the region of a discharging position. There, the previously formed dosing quantities are then discharged from the dosing openings, for example via positive pressure, and directed onwards to the target containers.

It is usually the case that such dosing drums are provided with a plurality of axis-parallel rows of dosing openings that are distributed uniformly over the circumference. The filling position, the discharging position and possibly further positions—such as a testing position, a cleaning position or the like—are positioned in accordance with the circumferential distance between such individual rows of dosing openings. As a result, one row of dosing openings is filled while, at the same time, a further row of dosing openings is being tested, emptied or cleaned. For each of these stepwise operations, there is therefore always an entire axis-parallel row of dosing openings undergoing the respective process step.

Such drum-type dosing apparatuses are suitable in particular for dosing small quantities, it being possible for the target containers to be positioned at the discharging position and for the row of associated dosing openings to be positioned in an axis-parallel row. Such a drum dosing process, meanwhile, has also proven successful for powders which do not lend themselves to being dosed. In high-speed filling machines with a high capacity, however, the aim is to have a multiple-row—typically a double-row—arrangement of the target containers. For example in the case of capsule-filling machines in which the lower parts of two-piece capsules serve as target containers, use is made of double-row format supports including two rows of for example 2×12 lower capsule parts. The drum-type filling machines known from the prior art are only ever capable of filling one row in one filling step. In such a case, it is therefore necessary to have a second drum-type filling machine, a second dosing station and possibly also a second filling cycle. Alongside the need for increased investment, there is also in particular a not inconsiderable amount of installation space required, which, in view of the confined conditions in a filling machine, is very difficult to provide.

### SUMMARY

It is an object of the disclosure is to provide a drum-type dosing apparatus such that target containers arranged in multiple rows can be filled at the same time with measured-out dosing quantities.

This object is, for example, achieved by a drum-type dosing apparatus for producing individual dosing quantities of a pulverulent product. The drum-type dosing apparatus includes: a product store arranged in a filling position; a dosing drum; a rotary drive for the dosing drum; the dosing drum defining at least two dosing openings spaced apart from one another in a circumferential direction of the dosing drum which are combined to conjointly form a dosing portion; and, the rotary drive being configured to stepwise rotate the dosing drum about an axis of rotation such that the dosing portion with ends up located, over a course of a cycle, at least in the filling position and in a discharging position.

According to the disclosure, provision is made for at least two dosing openings spaced apart from one another in a circumferential direction of the dosing drum to be combined to form a joint dosing portion. The rotary drive here is configured for stepwise rotation of the dosing drum about an axis of rotation such that an individual dosing portion with its associated dosing openings spaced apart in the circumferential direction ends up located, over the course of a cycle, at least in a filling position and in a discharging position.

The arrangement according to the disclosure makes it possible for more than one row, and in particular two rows, of target containers to be filled by a single drum-type dosing apparatus within a single operating step. In comparison with a single-row arrangement, there is no need for virtually any additional installation space, nor is any additional time required. The tried-and-tested means of the drum-type dosing apparatus, then, is therefore also readily available for filling machines with a high capacity and process speed and can therefore demonstrate its advantages in particular for dosing powders which do not lend themselves to being dosed.

It can be expedient to orient the dosing openings of the dosing portion radially in relation to the axis of rotation of the dosing drum, wherein, on account of the circumferential distance therebetween, they then enclose a specific opening angle. An embodiment, however, diverges from this. Rather, in this case, the dosing portion has a central plane running radially in relation to the axis of rotation, wherein the dosing openings are arranged in pairs on either side of the central plane. The dosing openings here have opening axes located parallel to one another and to the central plane. In the absence of a radial orientation of the opening axes, the aforementioned parallelism results in the dosing openings and the target containers to be filled being able to be aligned precisely with one another and in the discharged dosing quantities arriving accurately at the target containers assigned to them.

The product store, at the filling position, is open in the direction of the dosing drum by way of a dispensing opening. Advantageously in the circumferential direction, the dispensing opening has a width which spans the dosing openings spaced apart from one another in the circumferential direction. In a manner analogous to the above-described multiple-row filling operation of the target containers, this also makes it possible for the multiple-row dosing openings of an individual dosing portion to be filled in just a single operating step.

The product store expediently contains, adjacent to the dispensing opening, two stirrers for the product, the stirrers being spaced apart from one another in the circumferential direction. In an advantageous embodiment, the two stirrers have stirring axes, located parallel to one another and to the axis of rotation, and can be driven in opposite directions. This results in fluidization of the supply of powder in the immediate vicinity of the dosing openings positioned there, and spaced apart in the circumferential direction, so that homogeneous filling of these dosing openings can be expected.

The powder product can be introduced into the dosing openings, and also discharged and transferred into the target containers, mechanically and/or under gravitational force. In an embodiment, the individual dosing openings are delimited on the inside via a filter element and can be connected, through the filter element, to a negative-pressure source. It is advantageously the case that, as an alternative or in addition to the negative-pressure source, they can be connected, through the filter element, to a positive-pressure source. The negative pressure provides, as a result of the powder being taken in by suction, for uniform filling of the dosing openings and safeguarding against the powder dropping out prematurely. The use of positive pressure makes it possible for the quantity of powder to be blown out in full without any residues remaining, this therefore achieving a high level of process reliability along with reproducibly measured-out dosing quantities in the target containers.

### BRIEF DESCRIPTION OF THE DRAWING

The invention will now be described with reference to the drawing wherein:

FIG. 1 shows, schematically and in section, a perspective view of a drum-type dosing apparatus with a total of four dosing portions distributed uniformly over the circumference and with two rows of dosing openings within each dosing portion.

### DETAILED DESCRIPTION

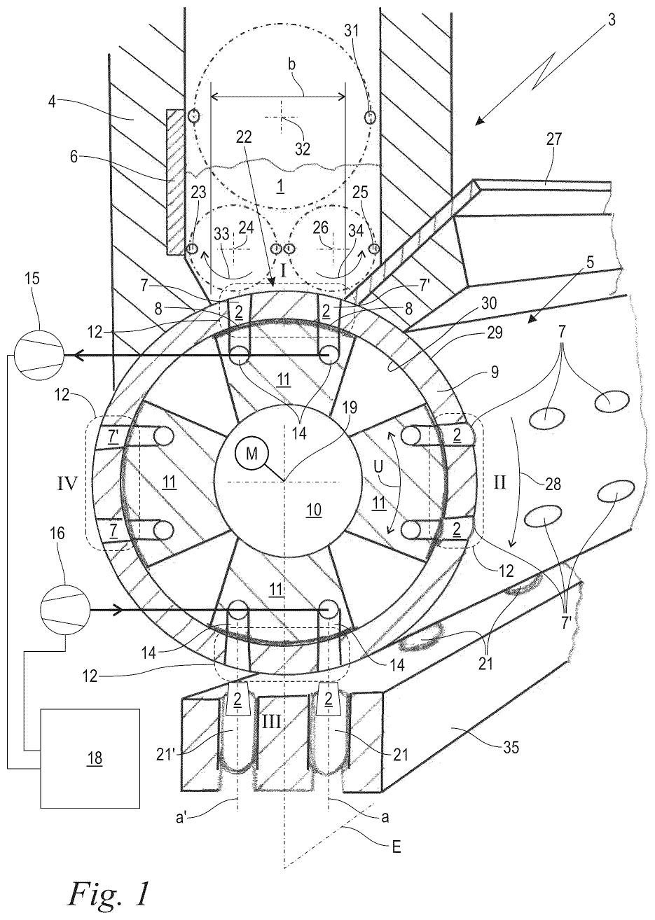

FIG. 1 shows a schematic and perspective cross-sectional illustration of a drum-type dosing apparatus 3 while it is producing individual dosing quantities 2 of a pulverulent product 1 and transferring such individual dosing quantities 2 into target containers 21, 21′. The pulverulent product here is a pharmaceutical powder. However, it can also be a pulverulent food supplement or the like. The target containers 21, 21′ are in this case schematically indicated lower parts of two-piece capsules, which, once filled, are closed by upper capsule parts being fitted on. However, blisters or other types of container are also possible options for target containers 21, 21′.

The drum-type dosing apparatus 3 includes a product store 4, a dosing drum 5 and also a rotary drive M (only indicated schematically here) for a stepwise rotary movement of the dosing drum 5 about an axis of rotation 19 in a direction of rotation indicated by an arrow 28. The rotary drive M can be a stepper motor or in particular a servomotor. Other suitable rotary drives M can also be considered.

The dosing drum 5 extends along a longitudinal axis identical to the aforementioned axis of rotation 19 and, as seen in relation to this longitudinal axis, is of essentially cylindrical configuration. The dosing drum 5 has a plurality of dosing openings 7, 7′ on its circumference and distributed over its circumference. At least two dosing openings 7, 7′ spaced apart from one another in a circumferential direction U of the dosing drum 5 are combined to form a joint dosing portion 12. In the embodiment shown, the dosing drum 5 is provided with a plurality of-in this case a total of four-dosing portions 12 distributed uniformly over the circumference. Accordingly, four dosing portions 12 are positioned at equal angular distances apart, that is, at 90° in relation to one another, in the circumferential direction around the axis of rotation 19.

Each of these dosing portions has at least two dosing openings 7, 7′ spaced apart from one another in the circumferential direction U. In other words, each dosing portion 12 has at least a first dosing opening 7 and at least a second dosing opening 7′, which, rather than being located in the same position in the circumferential direction U, are at a circumferential distance apart from one another. It is possible for the two dosing openings 7, 7′ to be offset in relation to one another in the direction of the longitudinal axis or in the direction of the axis of rotation 19. In the present case, in each case two dosing openings 7, 7′ form a pair, the openings in the pair being at a distance apart from one another only in the circumferential direction U, but not in the direction of the axis of rotation 19. Within the context of the disclosure, it can be sufficient for each dosing portion 12 to contain just one pair of dosing openings 7, 7′. In the embodiment shown, each dosing portion 12 contains a plurality of-in this case two-rows of dosing openings 7, 7′, the rows being spaced apart from one another in the circumferential direction U. In other words, in each case two or more, preferably three to twelve, first dosing openings 7 form a first row of openings, running axis-parallel to the axis of rotation 19. In a manner analogous to this, in each case two or more, preferably three to twelve, second dosing openings 7′ form a second row of openings, running axis-parallel to the axis of rotation 19 and also parallel to the first row of first dosing openings 7 and at a distance therefrom, as measured in the circumferential direction U.

The dosing openings 7, 7′ each have an opening axis a, a′. The opening axes a, a′ can be located radially in relation to the axis of rotation 19. In the present case, however, they are located parallel to one another and also parallel to a central plane E, wherein the central plane E is defined by a radial direction R running centrally through the respective dosing portion 12 and by the axis of rotation 19. In addition, the opening axes a, a′—as seen in a projection onto the central plane E—are located perpendicularly in relation to the axis of rotation 19.

The metering drum 5 has a central clamping core 10 and a drum casing 9, which surrounds the clamping core 10 at a radial distance therefrom. The dosing openings 7, 7′ are in the form of circular-outline bores which pass radially through the drum casing 9. Other outlines, however, can also be expedient. For example, the shape of the outline can be just partially round, oval, polygonal, rectangular or square. The dosing openings 7, 7′ are open in the radially outward direction, that is, on an outer side 29 of the drum casing 9. In the radially inward direction, that is, on an inner side 30 of the drum casing 9, they are delimited via a respective filter element 8, which corresponds in terms of size and shape to the cross section of the respective dosing opening 7, 7′ and forms the base of the latter.

Filter strips 11 are arranged between the clamping core 10 and the drum casing 9. A respective filter strip 11 is provided for each dosing portion 12. The filter elements 8 are formed jointly by a sheet of suitable filter material, which is wrapped around the clamping core 10 with the filter strips 11. Stuck-on filter elements 8 can also be used. The filter strips 11 are braced in the radially outward direction, via a clamping cone (not illustrated), against the inner side 30 of the drum casing 9, with the interposition of the filter material.

Respectively branched pressure channels 14 are formed in the filter strips 11 and open out, through the filter elements 8, into corresponding dosing openings 7, 7′. The pressure channels 14 of each filter strip 11 can be subjected to a desired pressure, in a manner which will be described in more detail hereinbelow, independently of the pressure channels 14 of the other filter strips 11. The dosing openings 7, 7′ are also subjected to this pressure through the pressure channels and through the respective filter element 8. The same pressure forms in all the dosing openings 7, 7′ of a respective dosing portion 12, but this occurs independently of the pressure in the dosing openings 7, 7′ of the respectively other dosing portions 12.

The dosing drum 5 is mounted for rotation about the axis of rotation 19. During operation, the dosing drum is rotated in a stepwise manner in the direction of the arrow 28 via the rotary drive M such that the individual dosing portions 12 end up located, over the course of a cycle in at least two steps, in an upper, filling position I—as seen in the direction of gravity—and in a discharging position III—as seen in the direction of gravity. In the embodiment shown, the individual dosing portions 12 with their pairs of dosing openings 7, 7′ pass through, over the course of the cycle, four different positions in four steps, beginning with the upper, filling position I, followed by a first intermediate position II. This is followed by the lower, discharging position III and a second intermediate position IV, before the cycle begins again at the upper, filling position I.

The product store 4 is located in the upper, filling position I, a sufficient supply quantity of the pulverulent product 1 to be dosed being held in the product store. There, the respective first dosing openings 7 and also the respective second dosing openings 7′ of the relevant dosing portion 12 are filled with the pulverulent product 1 from the product store 4, a respective dosing quantity 2 being formed in the process. For this purpose, the product store 4, at the filling position I, is open in the direction of the dosing drum 5 by way of a dispensing opening 22. In the circumferential direction U, the dispensing opening 22 has a width b which spans the dosing openings 7, 7′ of the one dosing portion 12 currently located there, the dosing openings being spaced apart from one another in the circumferential direction U. The first row of dosing openings 7 is located in the region of one edge of the dispensing opening 22, while the second row of dosing openings 7′ is located in the region of the opposite edge of the dispensing opening 22—as seen in the circumferential direction U. Accordingly, all the dosing openings 7, 7′ of the one dosing portion 12 currently located there come into contact with the pulverulent product 1 held in the product store 4 and are filled therewith at the same time in one operating step.

For the purpose of assisting the filling operation, the product store 4 is provided with an optional stirring unit. The stirring unit includes, directly adjacent to the dispensing opening 22, two stirrers 23, 25, which are spaced apart from one another in the circumferential direction U and are fully immersed in the pulverulent product 1. The two stirrers 23, 25 have stirrer axes 24, located parallel to one another and also parallel to the axis of rotation 19. Arrows 33, 34 indicate that, during operation, the two stirrers 23, 25 are driven in opposite directions, to be precise such that they move away from one another on their undersides, which face the dosing drum 5. As a result, the pulverulent product 1 is moved outwards to the opposite edges of the dispensing opening 22—as seen in the circumferential direction U and in the direction of rotation 28—that is, to where the dosing openings 7, 7′ of the dosing portion 12 currently positioned there are located.

It is optionally possible for yet another stirrer 31 with a stirrer axis 32, this stirrer being arranged centrally in the product store, to be provided above the two stirrers 23, 25. Moreover, for the purpose of ensuring a uniform filling operation, the product store 4 is also provided with a level sensor 6, via which the current filling level of the product 1 in the product store is determined and via which, as part of an open-loop or closed-loop process, it is possible for a refilling operation of the product to take place in order for a sufficiently uniform filling level in the product store 4 to be achieved.

The dosing portion 12 filled in such a way is moved onwards in the direction of rotation 28 via a stepwise rotary movement. A doctor blade 27, which does not rotate along, is arranged downstream of the product store 4—as seen in the direction of rotation 28—and rests on the rotatably advancing outer side 29 of the dosing drum 5 by way of spring prestressing, removes any product residues possibly adhering to the outer side 29. In a first, optional rotation step, the filled dosing portion 12 reaches the following, optional first intermediate position II, where for example filling-level monitoring can be carried out.

Following a further stepwise rotary movement, the aforementioned dosing portion 12 reaches the lower, discharging position III. There, the dosing quantities 2 are discharged from all the first dosing openings 7 and all the second dosing openings 7′ of this one dosing portion 12 and are fed to the target containers 21, 21′. For this purpose, the target containers 21, 21′ are arranged, in terms of number and position, in a manner corresponding to the dosing openings 7, 7′: First target containers 21 are arranged in a first row parallel to the axis of rotation 19. Second target containers 21′ are arranged in a second row parallel to the axis of rotation 19 and also parallel to the first row of first target containers 21. In the circumferential direction U, they are at a distance from one another which corresponds to the distance between the first and second dosing openings 7, 7′. Also in the direction of the axis of rotation 19, the distance between the target containers 21, 21′ corresponds to the distance between the dosing openings 7, 7′. In the case of the practical embodiment shown, the target containers 21, 21′, in the form of lower capsule parts, are held in two rows in a lower-capsule-part holder 35 of a capsule-filling machine. In the lower, discharging position III, the opening axes a, a′ of the dosing openings 7, 7′ are in alignment with the associated target containers 21, 21′. As a result of the parallelism of the opening axes a, a′ in relation to one another, the discharged dosing quantities 2 pass accurately into the intended target containers 21, 21′.

At the discharging position III, it is optionally possible to have, between one of the dosing drums 5 and the target containers 21, 21′, a measuring device (not illustrated here), in particular a capacitive measuring device for determining the mass of the individual dosing quantities 2. Such a capacitive measuring device is also referred to as an “Advanced Mass Verification System” or AMV system. It is thereby possible to test, for each individual dosing quantity 2 dropping through, whether the volumetric dosing has actually resulted in the desired target mass within a certain tolerance range. Density fluctuations in the powder, incompletely filled or emptied dosing openings 7, 7′ or the like can be identified in this way.

The now emptied dosing portion 12 is then moved onwards to the optional second intermediate position IV and can be cleaned there for example by having any remaining powder blown out of it.

The dosing openings 7, 7′, as already mentioned above, can be subjected as required to a desired pressure through the respective filter element 8. In the embodiment shown, at least for the dosing portion 12 located in the filling position I, a negative pressure is selected and a negative-pressure-transmitting connection is established for this purpose between the pressure channel 14 and a negative-pressure source 15. The level of the negative pressure supplied by the negative-pressure source 15 is set via a schematically indicated control unit 18, which can be done by way of appropriate open-loop control, but also possibly by closed-loop control. In any case, the negative pressure set in such a way is transmitted through the pressure channel 14 of the associated filter strip 11, and through the filter element 8, into the dosing openings 7, 7′ of that dosing portion 12 which is located in the upper, filling position I. The negative pressure sucks the pulverulent product 1 out of the product store 4 into the dosing openings 7, 7′. In terms of its permeability, the filter element 8 is configured, and coordinated with the product 1, such that, although it is permeable to air and therefore also transmits pressure, the pulverulent product 1 is held back and prevented from passing through. This results in the formation of individual dosing quantities 2 of the pulverulent product 1 which completely fill the dosing openings 7, 7′ and of which the volume corresponds to the volume of the respective dosing openings 7, 7′. In any case, depending on the level of negative pressure prevailing and on the properties of the product 1, there is a certain degree of compaction of the product 1 in the dosing openings 7, 7′, so that the predefined volume of the dosing openings 7, 7′ also gives rise to a certain mass of the individual dosing quantities 2.

The negative pressure applied can also be maintained at the same or a reduced level in the first intermediate position II, and until the discharging position III is reached, in order to prevent the dosing quantities 2 from dropping prematurely out of the dosing openings 7, 7′. At the latest when the lower, discharging position III is reached, however, the application of negative pressure is terminated. Instead, the dosing openings 7, 7′ of the dosing portion 12 located in the discharging position III are subjected to a positive pressure through the filter elements 8. For this purpose, a positive-pressure-transmitting connection is established between the pressure channel 14 of the associated filter strip 11 and a positive-pressure source 16. As in the aforementioned case of the negative-pressure source, the level of the positive pressure supplied by the positive-pressure source 16 is set via the schematically indicated control device 18. The positive pressure set in such a way is transmitted through the pressure channel 14, and the filter element 8, into the dosing openings 7, 7′ of the dosing portion 12 located in the lower discharging position III. The positive pressure blows the dosing quantities 2 out of the dosing openings 7, 7′. It is additionally possible for the application of positive pressure also to be used in the subsequent, second intermediate position IV for the operation of cleaning the emptied dosing openings 7, 7′ there.

It is understood that the foregoing description is that of the preferred embodiments of the invention and that various changes and modifications may be made thereto without departing from the spirit and scope of the invention as defined in the appended claims.

1. A drum-type dosing apparatus for producing individual dosing quantities of a pulverulent product, the drum-type dosing apparatus comprising:
a product store arranged in a filling position;
a dosing drum;
a rotary drive for the dosing drum;
said dosing drum defining at least two dosing openings spaced apart from one another in a circumferential direction of said dosing drum which are combined to conjointly form a dosing portion; and,
said rotary drive being configured to stepwise rotate said dosing drum about an axis of rotation such that said dosing portion with ends up located, over a course of a cycle, at least in said filling position and in a discharging position.

2. The drum-type dosing apparatus of claim 1, wherein said dosing portion includes two rows of said at least two dosing openings, said two rows being spaced apart from one another in the circumferential direction.

3. The drum-type dosing apparatus of claim 1, wherein said dosing portion has a central plane running radially in relation to the axis of rotation; said at least two dosing openings are arranged in pairs on either side of the central plane; and, said at least two dosing openings define opening axes located parallel to one another and to the central plane.

4. The drum-type dosing apparatus of claim 1, wherein said product store, at said filling position, is open in a direction of the dosing drum by way of a dispensing opening; and, in the circumferential direction, said dispensing opening has a width which spans said at least two dosing openings spaced apart from one another in the circumferential direction

5. The drum-type dosing apparatus of claim 4, wherein said product store includes, adjacent to said dispensing opening, two stirrers for the product; and, said two stirrers being spaced apart from one another in the circumferential direction.

6. The drum-type dosing apparatus of claim 5, wherein said two stirrers have stirrer axes, located parallel to one another and to the axis of rotation; and, said two stirrers are configured to be driven in opposite directions.

7. The drum-type dosing apparatus of claim 1, wherein individual one of said at least two dosing openings are delimited on an inside by a filter element and are configured to be connected, through said filter element, to a negative-pressure source.

8. The drum-type dosing apparatus of claim 1, wherein individual ones of said at least two dosing openings are delimited on the inside by a filter element and are configured to be connected, through said filter element, to a positive-pressure source.
